(19) United States
(12) Patent Application Publication
(10) Pub. No.: US 2019/0026924 A1
(43) Pub. Date: Jan. 24, 2019

(54) Method and Apparatus for Calibration of a Multi-Camera System

(71) Applicant: Nokia Technologies Oy, Espoo (FI)

(72) Inventor: Kimmo Roimela, Tampere (FI)

(21) Appl. No.: 16/069,244

(22) PCT Filed: Jan. 12, 2017
(86) PCT No.: PCT/FI17/50011

§ 371 Date: Jul. 11, 2018

(30) Foreign Application Priority Data
Jan. 15, 2016 (FI) 20165021

(51) Int. Cl. G06T 7/80; G06T 7/231; H04N 13/246; H04N 13/139

(52) U.S. Cl. CPC G06T 7/85; G06T 7/231; G06T 2207/10012; H04N 13/139; H04N 13/246

(57) ABSTRACT

There are disclosed various methods and apparatuses for calibration of a multi-camera system. In some embodiments of the method a first image captured by a first camera unit of a multi-camera system and a second image captured by a second camera unit of the multi-camera system are obtained. A two-dimensional optical flow between the first camera unit and the second camera unit is determined by using the first image and the second image. The two-dimensional optical flow is converted into a three-dimensional rotation. A parallax component of the three-dimensional rotation is removed by using extrinsic parameters of the first camera unit and the second camera unit. The modified three-dimensional rotations are used to obtain a first error estimate for the first camera unit and a second error estimate for the second camera unit. In some embodiments the apparatus comprises means for implementing the method.

### TECHNICAL FIELD

The present invention relates to a method for calibration of a multi-camera system, an apparatus for calibration of a multi-camera system, and computer program for calibration of a multi-camera system.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A multi-camera system comprises two or more camera units capable of capturing images and/or video. The camera units may be positioned in different ways with respect to each other camera unit. For example, in a two-camera system the camera units may be located at a short distance from each other and they may view to the same direction so that the two-camera system can provide a stereo view of the environment. In another example, the multi-camera system may comprise more than two cameras which are located in an omnidirectional manner. Hence, the viewing angle of such a multi-camera system may be even 360°. In other words, the multi-camera system may be able to view practically around the multi-camera system.

Each camera unit of the multi-camera system may produce images and/or video information i.e. visual information. The plurality of visual information captured by different camera units may be combined together to form an output image and/or video. For that purpose an image processor may use so called extrinsic parameters of the multi-camera system, such as orientation and relative position of the camera units, and possibly intrinsic parameters of the camera units to control image warping operations which may be needed to provide a combined image in which details captured with different camera units are properly aligned. In other words, two or more camera units may capture at least partly same areas of the environment, wherein the combined image should be formed so that same areas from images of different camera units should be located at the same location.

A multi-camera system may be calibrated during the manufacturing phase so that the extrinsic parameters should be correct. However, storing, packing, transporting and/or using the multi-camera system may affect that the relative position of the camera units may change, which would mean that the original extrinsic parameters may no longer be correct. Thus, accurate calibration of each individual camera unit with respect to each other may be a prerequisite for real-time video playback and stereo reconstruction of multi-camera video, for example, and may greatly help post-processing of such content.

A problem in a multi-camera system may be that while the orientation and relative position of each camera unit are known to some accuracy based on the construction of the system, assembly and installation tolerances may result in variation that still may need to be measured and corrected case by case.

### SUMMARY

Various embodiments provide a method and apparatus for calibration of a multi-camera system. In accordance with an embodiment, there is provided a method for calibration of a multi-camera system. In accordance with an embodiment, optical flows between all camera pairs of a multi-camera system are analyzed, each of per-pixel two-dimensional (2D) optical flow vectors is then converted into an equivalent three-dimensional (3D) rotation, and by using initial extrinsic parameters, a parallax component of these rotations may be mostly cancelled out. The resulting per-pixel 3D error rotations to all other cameras may then be summed up and averaged for each camera unit, arriving at per-camera estimates of the error.

Various aspects of examples of the invention are provided in the detailed description.

According to a first aspect, there is provided a method comprising:

obtaining a first image captured by a first camera unit of a multi-camera system;

obtaining a second image captured by a second camera unit of the multi-camera system;

determining a two-dimensional optical flow between the first camera unit and the second camera unit on the basis of the first image and the second image by selecting one or more locations in the first image and performing a search in the second image for finding a corresponding location in the second image;

converting the two-dimensional optical flow into a three-dimensional rotation;

removing a parallax component of the three-dimensional rotation by using extrinsic parameters of the first camera unit and the second camera unit;

using the modified three-dimensional rotations to obtain a first error estimate for the first camera unit and a second error estimate for the second camera unit; and

using the estimated correction to adjust extrinsic parameters of at least one of the first camera unit and the second camera unit.

According to a second aspect, there is provided an apparatus comprising at least one processor; and at least one memory including computer program code the at least one memory and the computer program code configured to, with the at least one processor, cause the apparatus to perform at least the following:

obtain a first image captured by a first camera unit of a multi-camera system;

obtain a second image captured by a second camera unit of the multi-camera system;

determine a two-dimensional optical flow between the first camera unit and the second camera unit by using the first image and the second image;

convert the two-dimensional optical flow into a three-dimensional rotation;

remove a parallax component of the three-dimensional rotation by using extrinsic parameters of the first camera unit and the second camera unit; and

use the modified three-dimensional rotations to obtain a first error estimate for the first camera unit and a second error estimate for the second camera unit; and

use the estimated correction to adjust extrinsic parameters of at least one of the first camera unit and the second camera unit.

According to a third aspect, there is provided an apparatus comprising at least one processor; and at least one memory including computer program code the at least one memory and the computer program code configured to, with the at least one processor, cause the apparatus to perform at least the following:

means for obtaining a first image captured by a first camera unit of a multi-camera system;

means for obtaining a second image captured by a second camera unit of the multi-camera system;

means for determining a two-dimensional optical flow between the first camera unit and the second camera unit by using the first image and the second image;

means for converting the two-dimensional optical flow into a three-dimensional rotation;

means for removing a parallax component of the three-dimensional rotation by using extrinsic parameters of the first camera unit and the second camera unit; and

means for using the modified three-dimensional rotations to obtain a first error estimate for the first camera unit and a second error estimate for the second camera unit; and

means for using the estimated correction to adjust extrinsic parameters of at least one of the first camera unit and the second camera unit.

According to a fourth aspect, there is provided a computer readable storage medium stored with code thereon for use by an apparatus, which when executed by a processor, causes the apparatus to perform:

obtain a first image captured by a first camera unit of a multi-camera system;

obtain a second image captured by a second camera unit of the multi-camera system;

determine a two-dimensional optical flow between the first camera unit and the second camera unit by using the first image and the second image;

convert the two-dimensional optical flow into a three-dimensional rotation;

remove a parallax component of the three-dimensional rotation by using extrinsic parameters of the first camera unit and the second camera unit; and

use the modified three-dimensional rotations to obtain a first error estimate for the first camera unit and a second error estimate for the second camera unit; and

use the estimated correction to adjust extrinsic parameters of at least one of the first camera unit and the second camera unit.

### BRIEF DESCRIPTION OF THE DRAWINGS

For a more complete understanding of example embodiments of the present invention, reference is now made to the following descriptions taken in connection with the accompanying drawings in which:

FIG. 1a shows an example of a multi-camera system as a simplified block diagram, in accordance with an embodiment;

FIG. 1b shows a perspective view of a multi-camera system, in accordance with an embodiment;

FIG. 2 illustrates a definition of an epipolar plane and an epipolar line, in accordance with an embodiment;

FIG. 3a illustrates an example of a captured image, in accordance with an embodiment;

FIG. 3b illustrates a produced optical flow to an adjacent image of the image of FIG. 3a, in accordance with an embodiment;

FIG. 3c illustrates the adjacent image warped using analyzed optical flow vectors, in accordance with an embodiment;

FIG. 4a illustrates an image with three dimensional rotations from the optical flow, in accordance with an embodiment;

FIG. 4b illustrates the rotations of FIG. 4a with a parallax component removed, in accordance with an embodiment;

FIG. 5 shows an estimate of overall error obtained by averaging world space error terms over other images, in accordance with an embodiment;

FIG. 6 shows a flowchart of a method of an optical flow estimation for one image pair, in accordance with an embodiment;

FIG. 7 shows a flowchart of a method of an optical flow estimation for one image pair, in accordance with an embodiment;

FIG. 8 shows a flowchart of a method of an optical flow estimation for one image pair, in accordance with an embodiment;

FIG. 9 shows a flowchart of a method for applying per-camera corrections, in accordance with an embodiment;

FIG. 10 shows a flowchart of a method for applying per-camera corrections, in accordance with an embodiment;

FIG. 11 shows a flowchart of a method for correcting possible overall system orientation, in accordance with an embodiment;

FIG. 12a shows a schematic block diagram of an exemplary apparatus or electronic device;

FIG. 12b shows an apparatus according to an example embodiment;

FIG. 13 shows an example of an arrangement for wireless communication comprising a plurality of apparatuses, networks and network elements.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

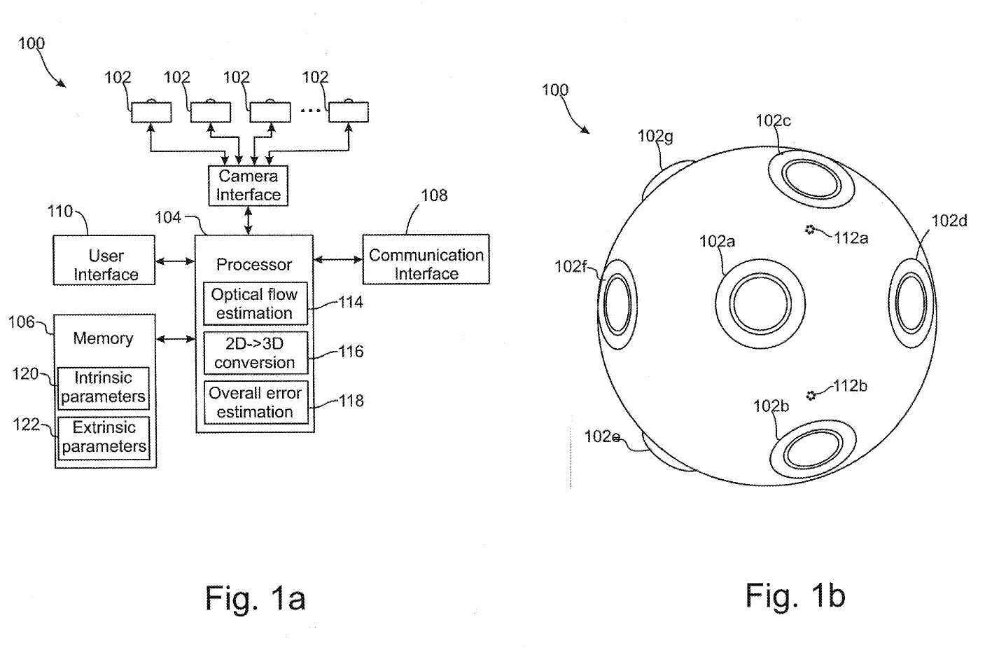

FIG. 1a illustrates an example of a multi-camera system 100, which comprises two or more camera units 102. In this example the number of camera units 102 is eight, but may also be less than eight or more than eight. Each camera unit 102 is located at a different location in the multi-camera system and may have a different orientation with respect to other camera units 102. As an example, the camera units 102 may have an omnidirectional constellation so that it has a 360° viewing angle in a 3D-space. In other words, such multi-camera system 100 may be able to see each direction of a scene so that each spot of the scene around the multi-camera system 100 can be viewed by at least one camera unit 102.

Without losing generality, any two camera units 102 of the multi-camera system 100 may be regarded as a pair of camera units 102. Hence, a multi-camera system of two cameras has only one pair of camera units, a multi-camera system of three cameras has three pairs of camera units, a multi-camera system of four cameras has six pairs of camera units, etc. Generally, a multi-camera system 100 comprising N camera units 102, where N is an integer greater than one, has N(N−1)/2 pairs of camera units 102. Accordingly, images captured by the camera units 102 at a certain time may be considered as N(N−1)/2 pairs of captured images.

The multi-camera system 100 of FIG. 1a may also comprise a processor 104 for controlling the operations of the multi-camera system 100. There may also be a memory 106 for for storing data and computer code to be executed by the processor 104, and a transceiver 108 for communicating with, for example, a communication network and/or other devices in a wireless and/or wired manner. The user device 100 may further comprise a user interface (UI) 110 for displaying information to the user, for generating audible signals and/or for receiving user input. However, the multi-camera system 100 need not comprise each feature mentioned above, or may comprise other features as well. For example, there may be electric and/or mechanical elements for adjusting and/or controlling optics of the camera units 102 (not shown).

FIG. 1a also illustrates some operational elements which may be implemented, for example, as a computer code in the software of the processor, in a hardware, or both. An optical flow estimation element 114 may perform optical flow estimation to pair of images of different camera units 102; a 2D to 3D converting element 116 may convert per-pixel optical flows into the 3D error component rotations; and an overall error estimation element 118 may perform overall error estimation for each camera unit 102. The operation of the elements will be described later in more detail. It should be noted that there may also be other operational elements in the multi-camera system 100 than those depicted in FIG. 1a.

FIG. 1b shows as a perspective view an example of an apparatus comprising the multi-camera system 100. In FIG. 1b seven camera units 102a-102g can be seen, but the multi-camera system 100 may comprise even more camera units which are not visible from this perspective. FIG. 1b also shows two microphones 112a, 112b, but the apparatus may also comprise one or more than two microphones.

In accordance with an embodiment, the multi-camera system 100 may be controlled by another device (not shown), wherein the multi-camera system 100 and the other device may communicate with each other and a user may use a user interface of the other device for entering commands, parameters, etc. and the user may be provided information from the multi-camera system 100 via the user interface of the other device.

Some terminology regarding the multi-camera system 100 will now be shortly described. A camera space, or camera coordinates, stands for a coordinate system of an individual camera unit 102 whereas a world space, or world coordinates, stands for a coordinate system of the multi-camera system 100 as a whole. An optical flow may be used to describe how objects, surfaces, and edges in a visual scene move or transform, when an observing point moves between from a location of one camera to a location of another camera. In fact, there need not be any actual movement but it may virtually be determined how the view of the scene might change when a viewing point is moved from one camera unit to another camera unit. A parallax can be regarded as a displacement or difference in the apparent position of an object when it is viewed along two different lines of sight. The parallax may be measured by the angle or semi-angle of inclination between those two lines.

Intrinsic parameters 120 may comprise, for example, focal length, image sensor format, and principal point. Extrinsic parameters 122 denote the coordinate system transformations from 3D world space to 3D camera space. Equivalently, the extrinsic parameters may be used to define the position of a camera center and camera's heading in world space.

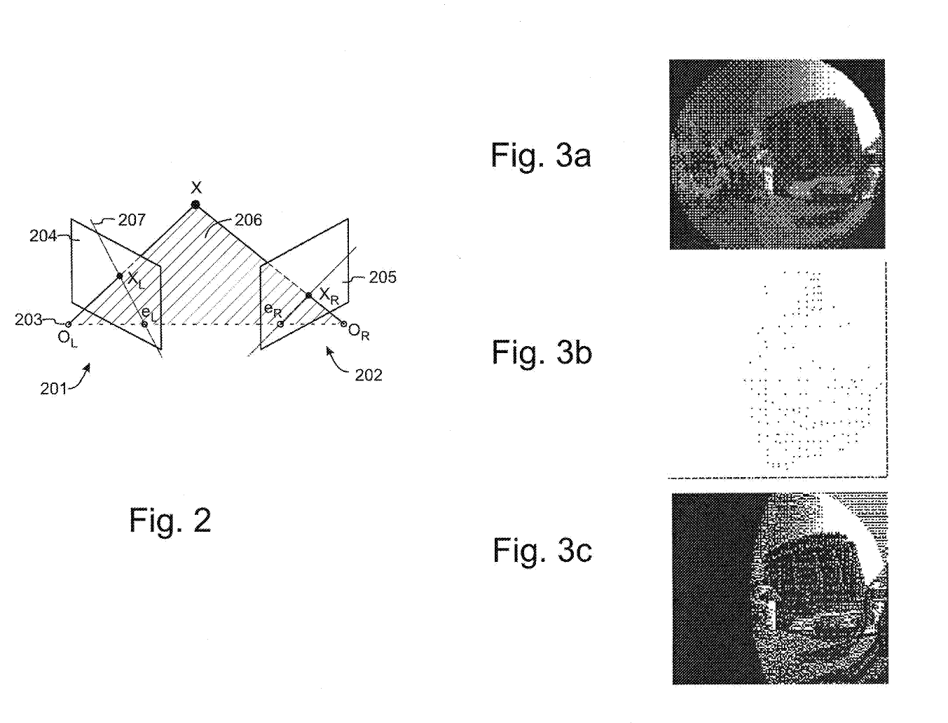

A definition of an epipolar plane and an epipolar line are illustrated in FIG. 2. There is shown a scene 200 with a point X, optical centres O_{L}, O_{R} of two pinhole cameras 201, 202, and views 204, 205 seen by the two cameras by an image sensor (not shown in FIG. 2). It should be stated that, for simplicity, the views 204, 205 are drawn in front of the optical centres O_{L}, O_{R} of the cameras with respect to the point X although in practical situations the view 204, 205 (and the image sensor) is behind the optical centre O_{L}, O_{R}. Also the image formed by the optics of the cameras 201, 202 on the image sensor may be a mirrored image. Because the optical centres O_{L}, O_{R} of the cameras are distinct from each other, the optical centres O_{L}, O_{R} may be virtually seen at a distinct point on the view of the other camera. In FIG. 2, the optical centre O_{L} of the left camera 201 seen by the right camera 202 is marked with letter e_{R} on the view 205 of the right camera. Respectively, the optical centre O_{R} of the right camera 202 seen by the left camera 201 is marked with letter e_{L} on the view 204 of the left camera 201. FIG. 2 further illustrates the projection X_{L}, X_{R} of the point X on the views 204, 205 of the cameras 201, 202, respectively. The optical centre O_{L} of the camera 201 on the left a virtual line which connects optical centres of two camera units 102. The epipolar plane 206 is the plane defined by the optical centres O_{L}, O_{R} of the cameras 201, 202 and the point X. The epipolar plane 206 intersects the view 204, 205 of the camera 201, 202, wherein the intersection may be regarded as an epipolar line 207. Hence, the location of the epipolar line is dependent on the location of the point X. However, if the relative position of the cameras 201, 202 remains unchanged, the epipolar line, defined by the point X, on the view of the left camera 201 and the corresponding epipolar line on the view of the right camera 201 has a certain mutual correspondence irrespective of the location of the point X. The mutual correspondence may be deduced on the basis of extrinsic parameters of the cameras, and, on the other hand, if the locations of the epipolar lines are known, this information may be used, possibly with some additional information, in determination of possible errors in the extrinsic parameters of the cameras.

In the following, a method for calibrating the multi-camera system 100 will be described in more detail, in accordance with an embodiment. Adjacent camera units 102 of the multi-camera system 100 may have partly overlapping views so that images of two (or even more than two) adjacent camera units 102 have partly common visual information but viewed from a slightly different viewpoint. This property may be utilized in the calibration process for example as follows.

To perform the calibration, the controller 104 may instruct the camera units 102 to capture one or more images at certain moment(s) of time. The images may be stored to the memory 106 for further use. In accordance with an embodiment, different camera units 102 capture the images substantially simultaneously to reduce errors which might exist if the scene were changed during the capturing process. In other words, each captured image may represent the same scene at the same moment of time but from different views.

In accordance with an embodiment, the controller 104 may use images captured previously and stored into memory. Hence, the camera units 102 need not perform image capturing to perform the calibration, if some previously captured images are available.

The controller 104 may process the images in a pair-wise manner, wherein there may be N(N−1)/2 pairs of images. However, not all these pairs of images may not always be needed in the calibration process, but it may be assumed that the more image pairs are used the more robust the calibration may be. First, one pair of adjacent camera units 102 and corresponding pair of images will be discussed in more detail. It can be assumed that there may be some overlap between images captured by adjacent camera units 102. Hence, it may be possible to analyze the image content for optical flow between the two images. This may be done, for example, by registering both images in the same coordinate system based on the, roughly correct, input extrinsic parameters. The coordinate system may be the coordinate system of one of the camera unit of the pair of camera units. Then, one or more locations may be selected in one image of the pair of images and a search may be performed for finding a corresponding location in the other image of the pair of images. This search may be performed so that image information of different locations of the other image is compared with the image information of the selected location and when a best match has been found, this location may be selected to represent the same location. In practice, input extrinsic camera parameters and the coordinates of the selected location in the one image may be used to estimate, where the corresponding location in the other image may be located. Then a small neighborhood of the corresponding location in the other image may be searched and the image content examined by evaluating an image similarity metric (such as mean square error) at each searched location, and choosing the location that minimizes the error or maximizes similarity. This process may output one or more 2D optical flow vectors in the coordinate system of the camera unit in question. FIG. 3a illustrates an example of a captured image 300, FIG. 3b illustrates the produced optical flow to an adjacent image, and FIG. 3c illustrates the adjacent image warped using the analyzed optical flow vectors.

Having the 2D optical flow vectors and the intrinsic and extrinsic transformation of each camera, the 2D optical flow vectors can be mapped from the camera space to corresponding 3D rotations in a coordinate system centric to the entire imaging system, in other words, to the world space.

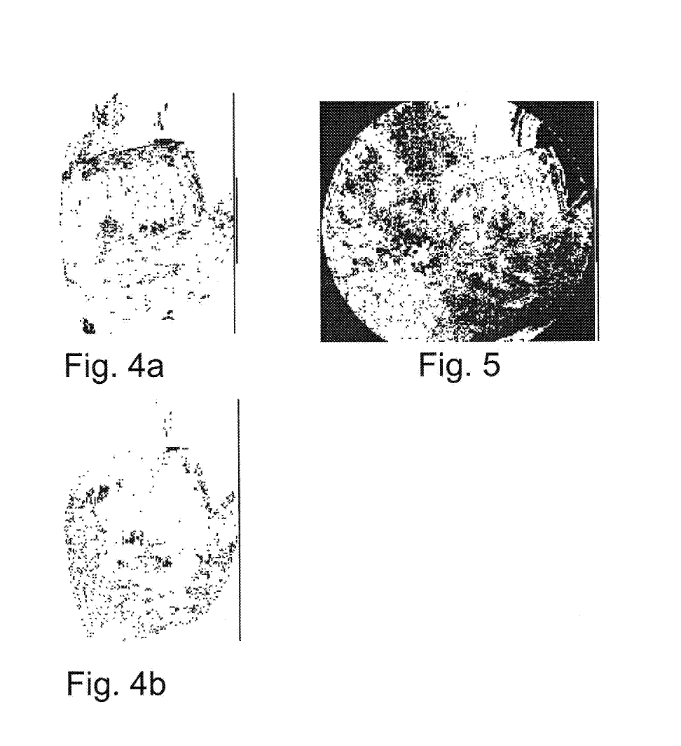

The resulting optical flow can be due to two components: parallax, resulting from the different viewpoints between the two camera units 102; and possible errors resulting from possibly incorrect camera extrinsic parameters. Such error(s) may exist in any direction, while a parallax effect may only occur in the direction of the line connecting the two cameras, i.e. the epipolar line. Using this information, a 3D rotation that is not about the epipolar line can be discarded. FIG. 4a shows an image with 3D rotations derived from the optical flow (3D rotation axis, the length of which corresponds to the amount of rotation) rendered as grayscale colors, and FIG. 4b shows the rotations with the parallax component removed.

Since there may be some error in the extrinsic parameters also in the direction of the epipolar line between each camera unit 102, the per-pair error estimation may lose some error. However, in a system of more than two camera units each individual camera may be surrounded by one or more adjacent cameras on more than side. By summing the per-pair error terms together, as shown in FIG. 5, an estimate of the overall error may be obtained.

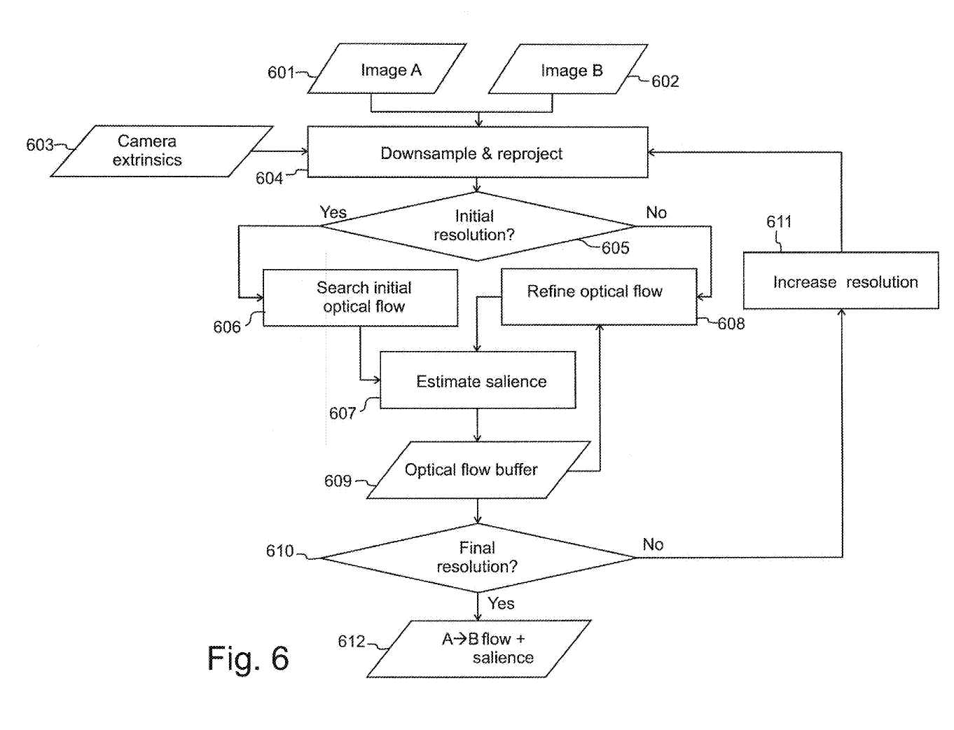

FIG. 6 shows a flowchart of a method of an optical flow estimation 114 for one image pair, in accordance with an embodiment. The images 601, 602 may first be downsampled to a lower resolution and possibly reprojected (block 604) for an efficient initial estimation of the optical flow. In this process the method may comprise using extrinsic parameters of the camera units 102 (block 603). After downsampling and possible reprojection in block 604 the process may continue to examine whether the resolution corresponds with an initial resolution. If so, initial optical flow may be searched (block 606). On the other hand, if the resolution does not correspond with the initial resolution, the optical flow may be refined (block 608). The refinement of the optical flow may also utilize optical flow information which may have been stored to an optical flow buffer (block 609) at an earlier phase of the process.

The initial optical flow from block 606 or the refined optical flow from block 608 may be used to estimate salience in block 607 and the resulting optical flow may be stored into the optical flow buffer at block 609. The salience estimation may be based on image content so that areas of the image with high-contrast edges may receive higher salience, whereas areas with no detail may receive lower salience. If a final resolution has been reached, the optical flow from the first image to the second image and salience may have been obtained (block 612). If the final resolution has not been reached, resolution may be increased in block 611 and the process may be repeated from block 604. In other words, the estimate may be iteratively refined at higher and higher resolutions until a desired resolution is arrived at.

In addition to per-pixel optical flow, a salience value may also be estimated based on the local image features at one or more pixels: for example, a completely flat image region may produce zero or almost zero salience, since there are no details to be matched in the other image, whereas a sharp edge or corner may give a higher salience. The salience can also be weighted based on the orientation of the features with respect to the epipolar line, for example.

In accordance with an embodiment, salience can further be adjusted by cross-checking optical flow between adjacent images, for example so that if a flow vector from pixel pA in an image A to pixel pB in an image B has a corresponding reverse flow vector from pB to pA, salience is high, but if the flow from pB points to a different pixel in A, salience is low as flow could not be robustly detected.

In the example implementation described above, the optical flow search runs on the controller 104 using the captured images directly and reprojecting the images on the fly, but it may also be possible to resample the images using a different projection before the optical flow search. It may also be possible to run the optical flow search by an entity which is not part of the multi-camera system 100, for example by an external computer, using previously captured images or video.

After the optical flow analysis, post processing may be applied to the resulting 2D flow map. For example, median filtering may help remove outliers from the flow data and give a more robust result. This post processing may also use the per-pixel salience values for weighting.

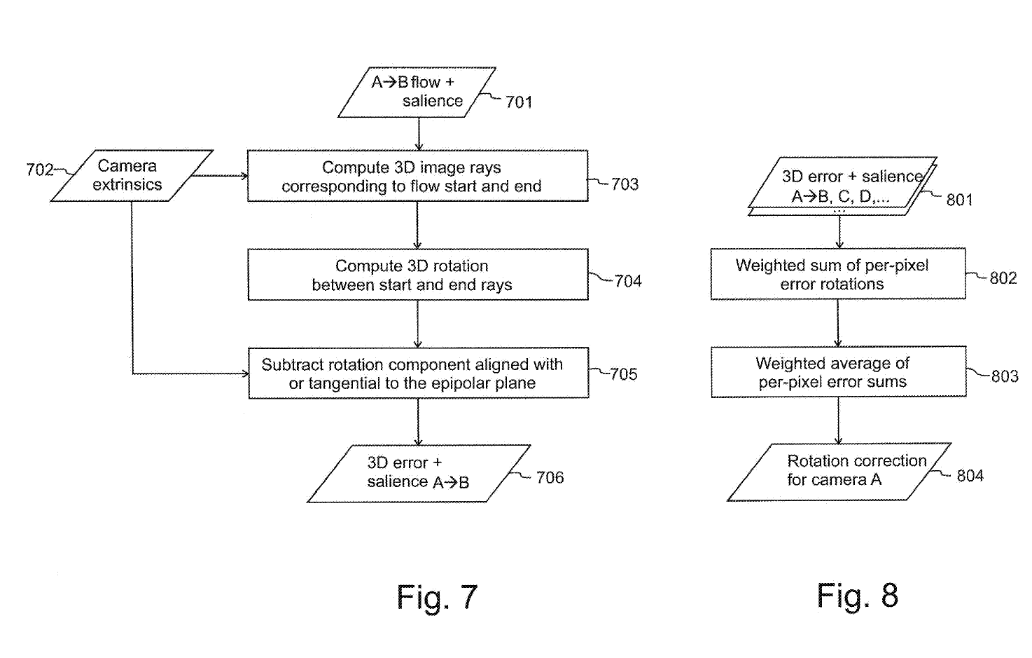

The per-pixel optical flows (block 701) may then be converted 116 into the 3D error component rotations as shown in FIG. 7. Using the camera intrinsic and extrinsic parameters (block 702), 3D direction vectors corresponding to the start and end locations of each 2D flow vector may be computed (block 703). By taking a cross product between the 3D direction vectors, the corresponding 3D rotation may be obtained (block 704). The camera extrinsic parameters may then be used to only keep the component of this rotation that is about the epipolar line (block 705). This may give per-pixel 3D error rotations, together with the salience values computed earlier (block 706).

In order to estimate 118 the overall error for each camera unit 102, the contributions from each overlapping image pair may be summed, as shown in FIG. 8. For example, in a multi-camera system of four camera units 102a, 102b, 102c, and 102d, for camera unit 102b image pairs 102b→102a, 102b→102c and 102b→102d may be selected (block 801) for calculating 3D error rotations, and the error contributions from each of those could be added up. These error contributions can also be weighted based on the per-pixel salience values (block 801). After summing the error contributions from the relevant camera unit pairs, the resulting sum of optical flow maps may be aggregated into a single per-camera correction term by computing a weighted average of the per-pixel optical flow sums (block 803). It should be noted that each pixel may correspond to a 3D rotation, so by averaging these rotations, a single 3D rotation that is the estimated correction which may be used to best align the camera unit in question with respect to the other cameras in the system may be arrived at (block 804).

After computing the per-camera corrections, they can be applied in a number of ways. For example, the corrections may be weighted by a constant factor to apply an average correction. The constant may be hardcoded, or it may come from user input: for example, there may be a slider shown on a touch panel display that the user can adjust to interactively adjust the magnitude of the correction.

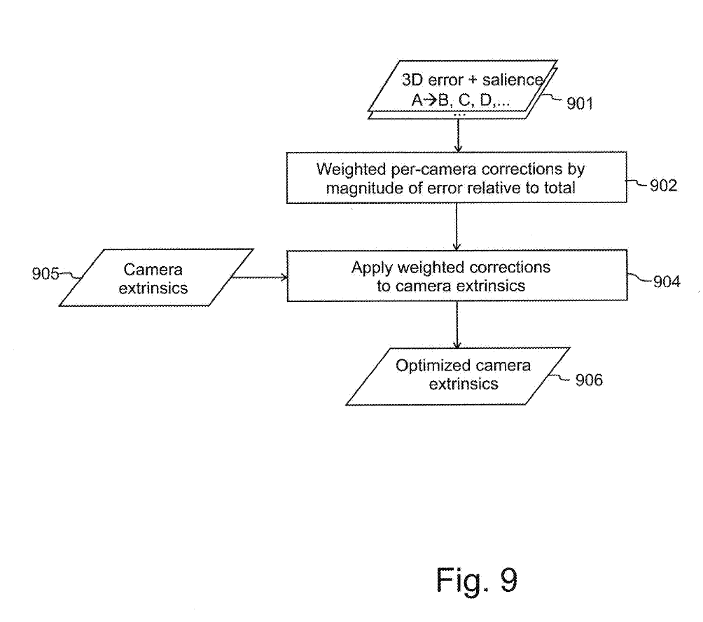

FIG. 9 shows an alternative embodiment, in which the per-camera corrections are weighted by the relative magnitude of the errors, so that a camera with higher error is corrected more than a camera with lower error. As in the example of FIG. 8, image pairs 102b→102a, 102b→102c and 102b→102d may be selected (block 901) and corrections per-camera unit 102 may be obtained by using a weighting factor based on the magnitude of the error relative to a total error (block 902). The weighted per-camera corrections may be applied to camera unit's extrinsic parameters (blocks 904, 905) to obtain optimized camera extrinsic parameters (block 906).

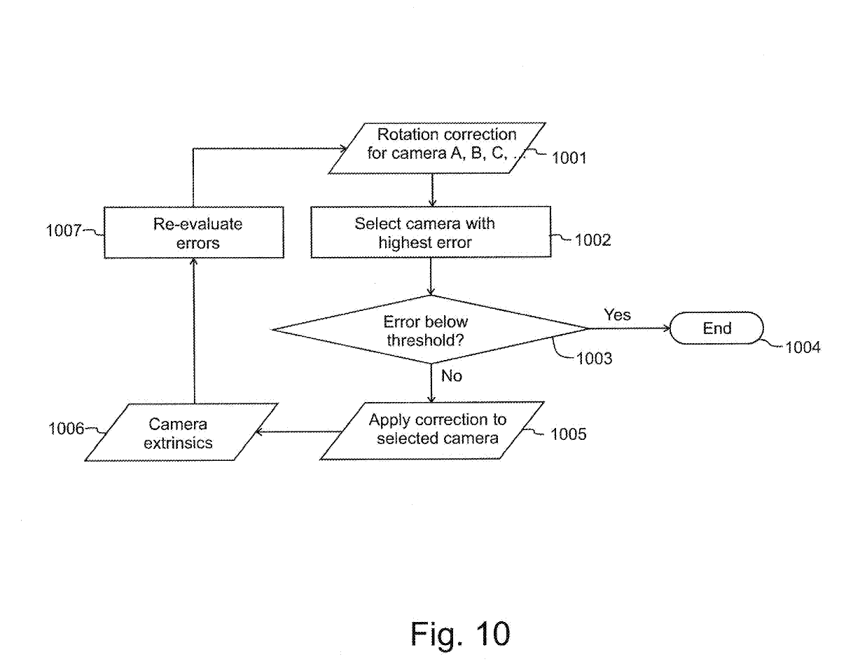

FIG. 10 shows another alternative embodiment, where only the camera unit with the biggest error is corrected first (block 1002), followed by re-evaluation of the errors (block 1007), and this may be repeated until all errors are below a set threshold (block 1003, 1004). The re-evaluation here may re-use previously computed optical flow results by applying the correction to the per-pixel flow vectors before re-evaluation (blocks 1005, 1006), so that some processing time can be saved by not having to completely redo the optical flow search at each iteration.

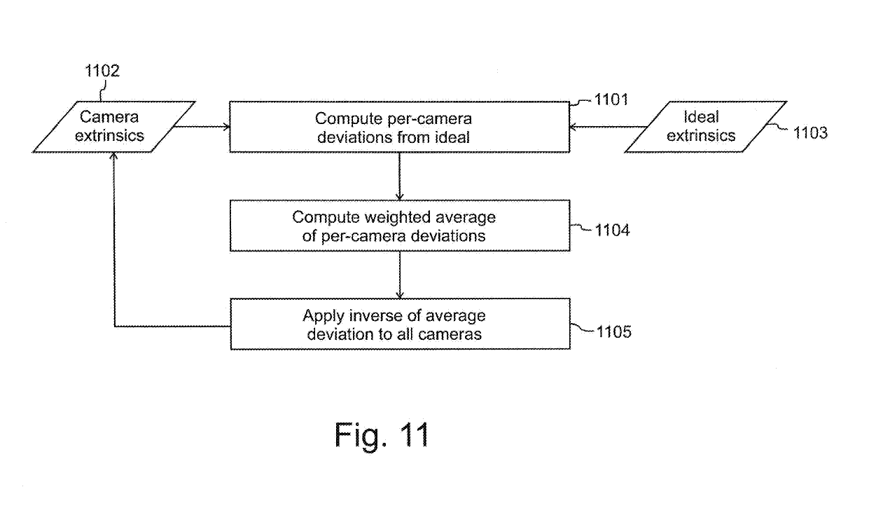

Having applied the per-camera corrections, the overall alignment may still contain a systematic error: all camera units in the camera system may contain error in the same direction. To counter this, the deviation each camera unit 102 may have from ideal extrinsic parameters (block 1103) can be computed (block 1101) based on the hardware design of the imaging system, and a correction for the average of these (block 1104) may be applied into all camera units (block 1105). Also this correction may be weighted based on the magnitude of per-camera unit error, for example, so that one wrongly aligned camera unit does not skew the result of the entire system. This is illustrated in FIG. 11, in accordance with an embodiment.

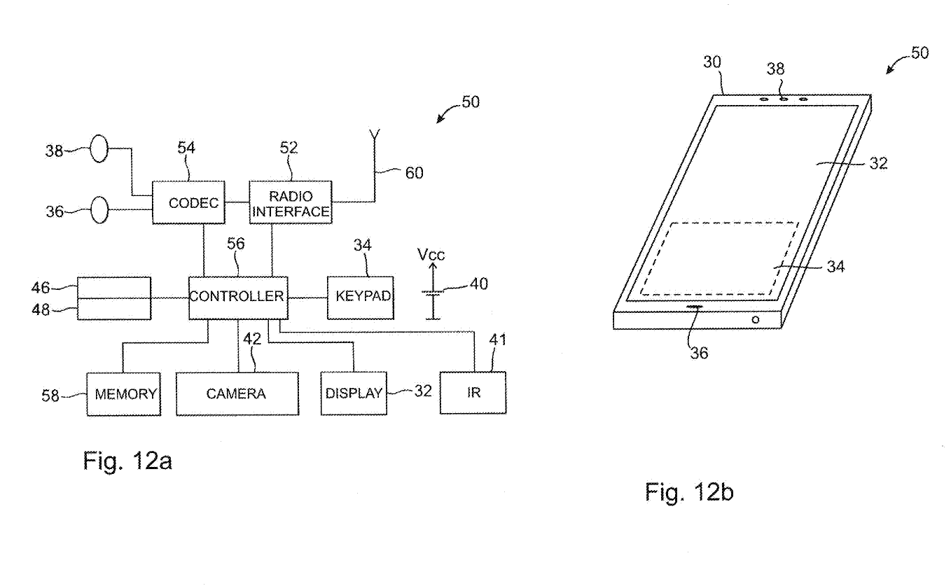

The following describes in further detail suitable apparatus and possible mechanisms for implementing the embodiments of the invention. In this regard reference is first made to FIG. 12a which shows a schematic block diagram of an exemplary apparatus or electronic device 50 depicted in FIG. 12b, which may incorporate a transmitter according to an embodiment of the invention.

The electronic device 50 may for example be a mobile terminal or user equipment of a wireless communication system. However, it would be appreciated that embodiments of the invention may be implemented within any electronic device or apparatus which may require transmission of radio frequency signals.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The term battery discussed in connection with the embodiments may also be one of these mobile energy devices. Further, the apparatus 50 may comprise a combination of different kinds of energy devices, for example a rechargeable battery and a solar cell. The apparatus may further comprise an infrared port 41 for short range line of sight communication to other devices. In other embodiments the apparatus 50 may further comprise any suitable short range communication solution such as for example a Bluetooth wireless connection or a USB/FireWire wired connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a universal integrated circuit card (UICC) reader and a universal integrated circuit card for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 60 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera 42 capable of recording or detecting imaging.

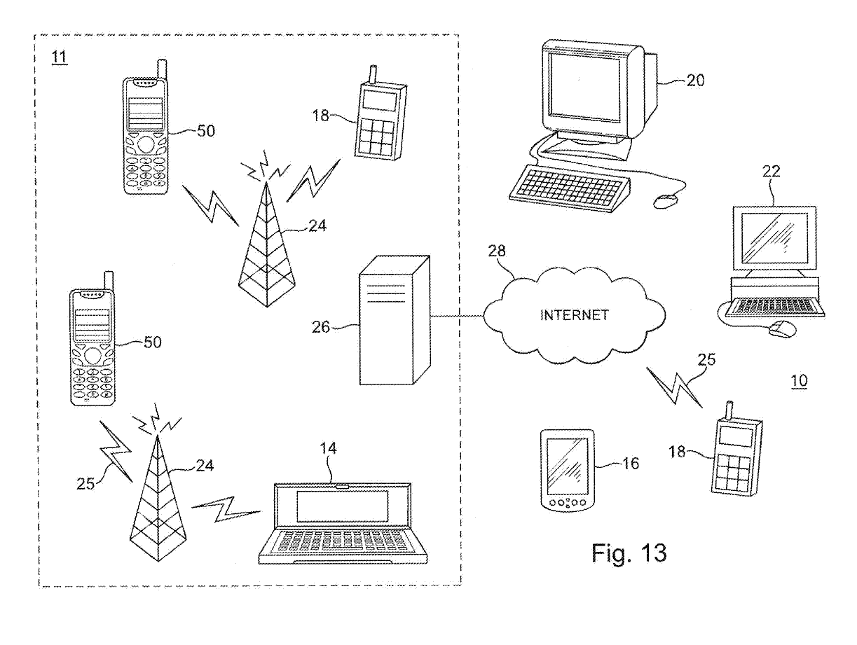

With respect to FIG. 13, an example of a system within which embodiments of the present invention can be utilized is shown. The system 10 comprises multiple communication devices which can communicate through one or more networks. The system 10 may comprise any combination of wired and/or wireless networks including, but not limited to a wireless cellular telephone network (such as a global systems for mobile communications (GSM), universal mobile telecommunications system (UMTS), long term evolution (LTE) based network, code division multiple access (CDMA) network etc.), a wireless local area network (WLAN) such as defined by any of the IEEE 802.x standards, a Bluetooth personal area network, an Ethernet local area network, a token ring local area network, a wide area network, and the Internet.

For example, the system shown in FIG. 13 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, a tablet computer. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, Long Term Evolution wireless communication technique (LTE) and any similar wireless communication technology. A communications device involved in implementing various embodiments of the present invention may communicate using various media including, but not limited to, radio, infrared, laser, cable connections, and any suitable connection. In the following some example implementations of apparatuses utilizing the present invention will be described in more detail.

Although the above examples describe embodiments of the invention operating within a wireless communication device, it would be appreciated that the invention as described above may be implemented as a part of any apparatus comprising a circuitry in which radio frequency signals are transmitted and received. Thus, for example, embodiments of the invention may be implemented in a mobile phone, in a base station, in a computer such as a desktop computer or a tablet computer comprising radio frequency communication means (e.g. wireless local area network, cellular radio, etc.).

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example, there is provided a method comprising:

obtaining a first image captured by a first camera unit of a multi-camera system;

obtaining a second image captured by a second camera unit of the multi-camera system;

determining a two-dimensional optical flow between the first camera unit and the second camera unit on the basis of the first image and the second image by selecting one or more locations in the first image and performing a search in the second image for finding a corresponding location in the second image;

converting the two-dimensional optical flow into a three-dimensional rotation;

removing a parallax component of the three-dimensional rotation by using extrinsic parameters of the first camera unit and the second camera unit; and

using the modified three-dimensional rotations to obtain a first error estimate for the first camera unit and a second error estimate for the second camera unit; and

using the estimated correction to adjust extrinsic parameters of at least one of the first camera unit and the second camera unit.

In some embodiments the method comprises:

estimating salience on the basis of the two-dimensional optical flow.

In some embodiments the method comprises:

examining whether the first image and the second image have a desired resolution; and

if not, changing the resolution of the first image and the second image towards the desired resolution.

In some embodiments of the method converting the two-dimensional optical flow into a three-dimensional rotation comprises:

computing three-dimensional direction vectors corresponding to a start and an end location of two-dimensional optical flow vectors;

taking a cross product between the three-dimensional direction vectors; and

using camera extrinsic parameters and subtracting a rotation component aligned with or tangential to an epipolar plane to only keep the component of the three-dimensional rotation that is about the epipolar line.

In some embodiments of the method estimating overall error of a camera unit comprises:

selecting image pairs from overlapping images captured by the first camera unit and the second camera unit;

calculating per-pixel error rotations for the image pairs;

summing the per-pixel error rotations; and

calculating an average of the per-pixel error sums to obtain an estimated correction.

In some embodiments the method comprises:

using the estimated correction to adjust extrinsic parameters of at least one of the first camera unit and the second camera unit.

According to a second example, there is provided an apparatus comprising at least one processor; and at least one memory including computer program code the at least one memory and the computer program code configured to, with the at least one processor, cause the apparatus to perform at least the following:

obtain a first image captured by a first camera unit of a multi-camera system;

obtain a second image captured by a second camera unit of the multi-camera system;

determine a two-dimensional optical flow between the first camera unit and the second camera unit by using the first image and the second image;

convert the two-dimensional optical flow into a three-dimensional rotation;

remove a parallax component of the three-dimensional rotation by using extrinsic parameters of the first camera unit and the second camera unit; and

use the modified three-dimensional rotations to obtain a first error estimate for the first camera unit and a second error estimate for the second camera unit; and

use the estimated correction to adjust extrinsic parameters of at least one of the first camera unit and the second camera unit.

According to a third example, there is provided an apparatus comprising:

means for obtaining a first image captured by a first camera unit of a multi-camera system;

means for obtaining a second image captured by a second camera unit of the multi-camera system;

means for determining a two-dimensional optical flow between the first camera unit and the second camera unit by using the first image and the second image;

means for converting the two-dimensional optical flow into a three-dimensional rotation;

means for removing a parallax component of the three-dimensional rotation by using extrinsic parameters of the first camera unit and the second camera unit; and

means for using the modified three-dimensional rotations to obtain a first error estimate for the first camera unit and a second error estimate for the second camera unit; and

means for using the estimated correction to adjust extrinsic parameters of at least one of the first camera unit and the second camera unit.

According to a fourth example, there is provided a computer readable storage medium stored with code thereon for use by an apparatus, which when executed by a processor, causes the apparatus to perform:

obtain a first image captured by a first camera unit of a multi-camera system;

obtain a second image captured by a second camera unit of the multi-camera system;

determine a two-dimensional optical flow between the first camera unit and the second camera unit by using the first image and the second image;

convert the two-dimensional optical flow into a three-dimensional rotation;

remove a parallax component of the three-dimensional rotation by using extrinsic parameters of the first camera unit and the second camera unit; and

use the modified three-dimensional rotations to obtain a first error estimate for the first camera unit and a second error estimate for the second camera unit; and

use the estimated correction to adjust extrinsic parameters of at least one of the first camera unit and the second camera unit.

1-16. (canceled)

17. A method comprising:
obtaining a first image captured by a first camera unit of a multi-camera system;
obtaining a second image captured by a second camera unit of the multi-camera system;
determining a two-dimensional optical flow between the first camera unit and the second camera unit on the basis of the first image and the second image by selecting one or more locations in the first image and performing a search in the second image for finding a corresponding location in the second image;
converting the two-dimensional optical flow into a three-dimensional rotation;
removing a parallax component of the three-dimensional rotation by using initial extrinsic parameters of the first camera unit and the second camera unit; and
using modified three-dimensional rotations to obtain a first error estimate for the first camera unit and a second error estimate for the second camera unit; and
using the error estimates to adjust extrinsic parameters of at least one of the first camera unit or the second camera unit.

18. The method according to claim 17 comprising:
estimating salience on the basis of the two-dimensional optical flow.

19. The method according to claim 17 comprising:
examining whether the first image and the second image have a desired resolution; and
if not, changing the resolution of the first image and the second image towards the desired resolution.

20. The method according to claim 17, wherein converting the two-dimensional optical flow into the three-dimensional rotation comprises:
computing three-dimensional direction vectors corresponding to a start and an end location of two-dimensional optical flow vectors;
taking a cross product between the three-dimensional direction vectors; and
using extrinsic parameters of a at least one of the first camera unit or the second camera unit and subtracting a rotation component aligned with or tangential to an epipolar plane to keep the component of the three-dimensional rotation that is about the epipolar line.

21. The method according to claim 17, wherein estimating error of the first camera unit or the second camera unit comprises:
selecting image pairs from overlapping images captured by the first camera unit and the second camera unit;
calculating per-pixel error rotations for the image pairs;
summing the per-pixel error rotations; and
calculating an average of the per-pixel error sums to obtain an estimated correction.

22. An apparatus comprising at least one processor; and at least one memory including computer program code the at least one memory and the computer program code configured to, with the at least one processor, cause the apparatus to perform at least the following:
obtain a first image captured by a first camera unit of a multi-camera system;
obtain a second image captured by a second camera unit of the multi-camera system;
determine a two-dimensional optical flow between the first camera unit and the second camera unit by using the first image and the second image;
convert the two-dimensional optical flow into a three-dimensional rotation;
remove a parallax component of the three-dimensional rotation by using extrinsic parameters of the first camera unit and the second camera unit;
use modified three-dimensional rotations to obtain a first error estimate for the first camera unit and a second error estimate for the second camera unit; and
use error estimates to adjust extrinsic parameters of at least one of the first camera unit or the second camera unit.

23. The apparatus according to claim 22, said at least one memory and the computer program code configured to, with the at least one processor, cause the apparatus to perform at least the following:
estimate salience on the basis of the two-dimensional optical flow.

24. The apparatus according to claim 22, said at least one memory and the computer program code configured to, with the at least one processor, cause the apparatus to perform at least the following:
examine whether the first image and the second image have a desired resolution; and
if not, changing the resolution of the first image and the second image towards the desired resolution.

25. The apparatus according to claim 22, said at least one memory and the computer program code configured to, with the at least one processor, cause the apparatus to perform at least the following:
compute three-dimensional direction vectors corresponding to a start and an end location of two-dimensional optical flow vectors;
take a cross product between the three-dimensional direction vectors; and
use extrinsic parameters of a at least one of the first camera unit or the second camera unit and subtracting a rotation component aligned with or tangential to an epipolar plane to keep the component of the three-dimensional rotation that is about the epipolar line.

26. The apparatus according to claim 22, said at least one memory and the computer program code configured to, with the at least one processor, cause the apparatus to perform at least the following:
select image pairs from overlapping images captured by the first camera unit and the second camera unit;
calculate per-pixel error rotations for the image pairs;
sum the per-pixel error rotations; and
calculate an average of the per-pixel error sums to obtain an estimated correction.

27. A computer readable storage medium stored with code thereon for use by an apparatus, which when executed by a processor, causes the apparatus to perform:
obtain a first image captured by a first camera unit of a multi-camera system;
obtain a second image captured by a second camera unit of the multi-camera system;
determine a two-dimensional optical flow between the first camera unit and the second camera unit by using the first image and the second image;
convert the two-dimensional optical flow into a three-dimensional rotation;
remove a parallax component of the three-dimensional rotation by using extrinsic parameters of the first camera unit and the second camera unit;
use modified three-dimensional rotations to obtain a first error estimate for the first camera unit and a second error estimate for the second camera unit; and
use error estimates to adjust extrinsic parameters of at least one of the first camera unit or the second camera unit.

28. The computer readable storage medium according to claim 27, wherein the code stored thereon, which when executed by a processor cause the apparatus to further perform at least the following:
estimate salience on the basis of the two-dimensional optical flow.

29. The computer readable storage medium according to claim 27, wherein the code stored thereon, which when executed by a processor cause the apparatus to further perform at least the following:
examine whether the first image and the second image have a desired resolution; and
if not, changing the resolution of the first image and the second image towards the desired resolution.

30. The computer readable storage medium according to claim 27, wherein the code stored thereon, which when executed by a processor cause the apparatus to further perform at least the following:
compute three-dimensional direction vectors corresponding to a start and an end location of two-dimensional optical flow vectors;
take a cross product between the three-dimensional direction vectors; and
use extrinsic parameters of a at least one of the first camera unit or the second camera unit and subtracting a rotation component aligned with or tangential to an epipolar plane to keep the component of the three-dimensional rotation that is about the epipolar line.

31. The computer readable storage medium according to claim 27, wherein the code stored thereon, which when executed by a processor cause the apparatus to further perform at least the following:
select image pairs from overlapping images captured by the first camera unit and the second camera unit;
calculate per-pixel error rotations for the image pairs;
sum the per-pixel error rotations; and
calculate an average of the per-pixel error sums to obtain an estimated correction.
